(19) United States
(12) Patent Application Publication
(10) Pub. No.: US 2026/0203155 A1
(43) Pub. Date: Jul. 16, 2026

(54) MACHINE LEARNING-BASED LOG ANOMALY DETECTION

(71) Applicant: Dell Products L.P., Round Rock, TX (US)

(72) Inventors: Ramakanth Kanagovi, Hyderabad (IN); Saheli Saha, Bengaluru (IN); Guhesh Swaminathan, Chennai (IN)

(21) Appl. No.: 19/025,242

(22) Filed: Jan. 16, 2025

(51) Int. Cl. G06F 11/07; G06F 16/901

(52) U.S. Cl. CPC G06F 11/079; G06F 11/0709; G06F 16/9024

(57) ABSTRACT

An apparatus comprises at least one processing device configured to obtain a query for performing anomaly detection and reasoning for input system logs comprising a sequence of identifiers for system events generated by information technology assets operating in an information technology infrastructure environment, to detect, utilizing a first machine learning model that takes as input the sequence of identifiers, anomalies in the input system logs, and to select, for a given one of the detected anomalies, a subset of a set of historical system logs based at least in part on computing similarity between a given input system log having the given detected anomaly and the historical system logs. The at least one processing device is further configured to determine, utilizing a second machine learning model that takes as input a prompt characterizing the query and the selected historical system logs, an anomaly reasoning for the given detected anomaly.

### BACKGROUND

As the value and use of information continues to increase, individuals and businesses seek additional ways to process and store information. Information processing systems may be used to process, compile, store and communicate various types of information, including through the use of artificial intelligence (AI) and machine learning (ML). Large language models (LLMs) are a type of AI system that uses ML algorithms to process vast amounts of natural language text data. LLMs may be used to perform various natural language processing (NLP) tasks, including text classification, text summarization, text generation, named entity recognition, text sentiment analysis, and question answering.

### SUMMARY

Illustrative embodiments of the present disclosure provide techniques for machine learning-based log anomaly detection.

In one embodiment, an apparatus comprises at least one processing device comprising a processor coupled to a memory. The at least one processing device is configured to obtain a query for performing anomaly detection and reasoning for one or more input system logs, the one or more input system logs comprising a sequence of identifiers for system events generated by one or more information technology assets operating in an information technology infrastructure environment. The at least one processing device is also configured to detect, utilizing a first machine learning model that takes as input information characterizing at least a portion of the sequence of identifiers, one or more anomalies in the one or more input system logs. The at least one processing device is further configured to select, for a given one of the detected one or more anomalies, a subset of a set of historical system logs, the set of historical system logs having detected anomalies with associated anomaly reasonings, the subset of the set of historical system logs being selected based at least in part on computing similarity metrics between (i) at least a portion of a given one of the one or more input system logs having the given detected anomaly and (ii) respective ones of the historical system logs in the set of historical system logs. The at least one processing device is further configured to determine, utilizing a second machine learning model that takes as input a prompt characterizing the query and the selected subset of the set of historical system logs, an anomaly reasoning for the given detected anomaly, and to provide an answer to the query based at least in part on the anomaly reasoning for the given detected anomaly.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for machine learning-based log anomaly detection in an illustrative embodiment.

FIG. 2 is a flow diagram of an exemplary process for machine learning-based log anomaly detection in an illustrative embodiment.

FIG. 3 shows a system including a log anomaly detection and reasoning agent configured for use with a large language model in an illustrative embodiment.

FIG. 4 shows a process flow for anomalous sub-sequence detection within system logs in an illustrative embodiment.

FIG. 5 shows an example system log block in an illustrative embodiment.

FIG. 6 shows a process flow for generating a vector embedding store with vector embeddings for historical system logs with anomalies in an illustrative embodiment.

FIG. 7 shows a process flow for anomaly detection and reasoning using a log anomaly detection and reasoning large language model agent in an illustrative embodiment.

FIG. 8 shows an example of system log blocks converted to a data structure in an illustrative embodiment.

FIG. 9 shows a table of message identifiers, descriptions and severities in an illustrative embodiment.

FIG. 10 shows a data structure with information for multiple log sequences in an illustrative embodiment.

FIG. 11 shows generation of graph structures for log sequences with anomalies in an illustrative embodiment.

FIG. 12 shows an example dictionary string data structure in an illustrative embodiment.

FIG. 13 shows an example log sequence including an anomalous sub-sequence in an illustrative embodiment.

FIGS. 14 and 15 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

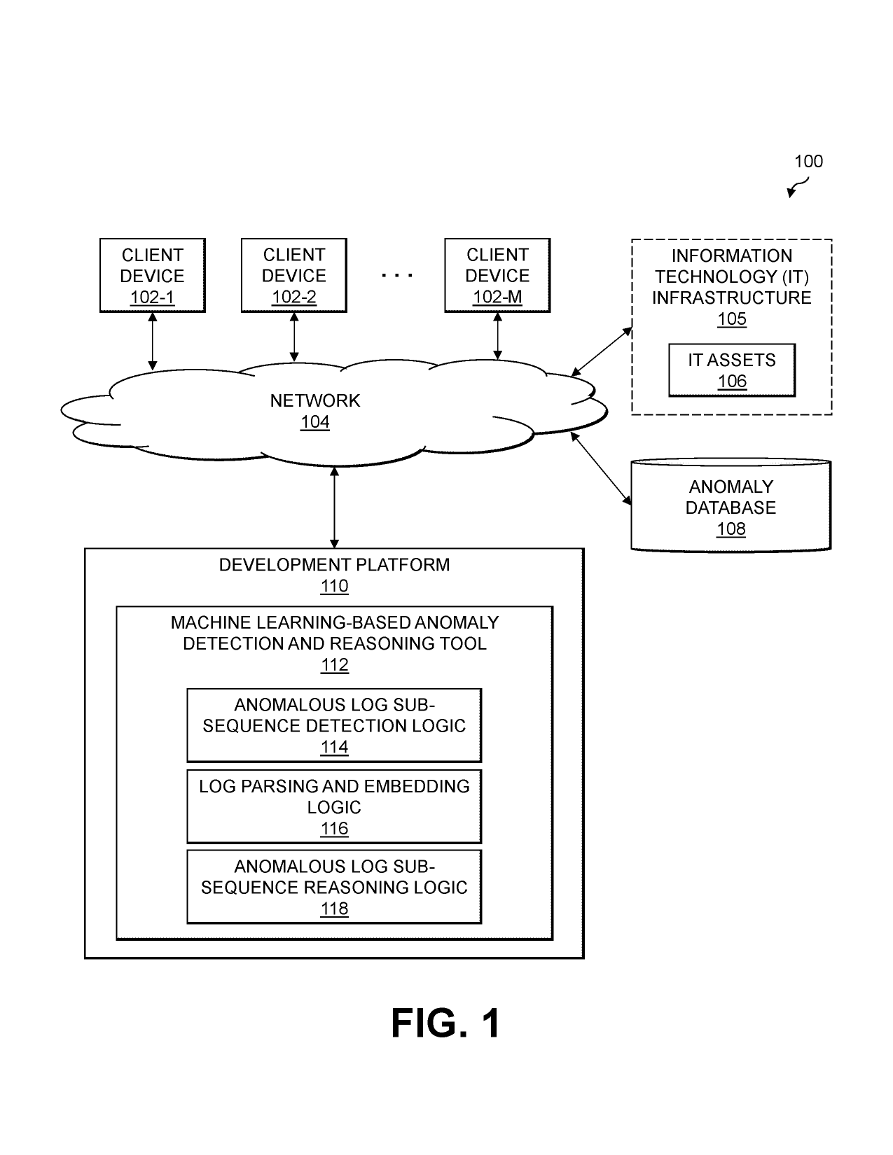

FIG. 1 shows an information processing system 100 configured in accordance with an illustrative embodiment. The information processing system 100 is assumed to be built on at least one processing platform and provides functionality for machine learning-based log anomaly detection. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, an anomaly database 108, and a development platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the development platform 110 is used for an enterprise system. For example, an enterprise may subscribe to or otherwise utilize the development platform 110 for analyzing system logs (e.g., generated by testing or otherwise operating the IT assets 106 of the IT infrastructure 105) to perform anomaly detection and reasoning for detected anomalies in the system logs, for an enterprise, organization or other entity. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The anomaly database 108 is configured to store and record various information that is utilized by the development platform 110. Such information may include, for example, artificial intelligence (AI) and machine learning (ML) models used for anomaly detection and reasoning, including AI/ML models such as Large Language Models (LLMs), Retrieval Augmented Generation (RAG) processing, Graph Neural Network (GNN) models, etc., vector embeddings or other types of formatted system logs which are suitable for use as input for such AI/ML models, historical system logs including those with anomalies and their associated reasoning, system logs to be analyzed, etc. The anomaly database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the development platform 110, as well as to support communication between the development platform 110 and other related systems and devices not explicitly shown.

The development platform 110 may be provided as a cloud service that is accessible by one or more of the client devices 102 to allow users thereof to perform anomaly detection and reasoning for system logs (e.g., generated by the client devices 102 themselves, IT assets 106 of the IT infrastructure 105, etc.) for different users of an enterprise, organization or other entity. In some embodiments, the client devices 102 are utilized by members of the same enterprise, organization or other entity that operates the development platform 110. In other embodiments, the client devices 102 are utilized by members of one or more enterprises, organizations or other entities different than the enterprise, organization or other entity that operates the development platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the anomaly database 108 and the development platform 110 regarding user prompts for system log analysis, including detection of anomalies and reasoning for detected anomalies. It should be noted that a “host agent” as this term is generally used herein may comprise an automated entity, such as a software entity running on a processing device. Accordingly, a host agent need not be a human entity.

The development platform 110 in the FIG. 1 embodiment is assumed to be implemented using at least one processing device. Each such processing device generally comprises at least one processor and an associated memory, and implements one or more functional modules or logic for controlling certain features of the development platform 110. In the FIG. 1 embodiment, the development platform 110 implements a machine learning-based anomaly detection and reasoning tool 112. The machine learning-based anomaly detection and reasoning tool 112 comprises anomalous log sub-sequence detection logic 114, log parsing and embedding logic 116, and anomalous log sub-sequence reasoning logic 118. The machine learning-based anomaly detection and reasoning tool 112 may comprise an agent that is configured for use with an LLM, with the LLM-based agent being configured to detect prompts which are input to the LLM for system log anomaly detection and reasoning. On detecting such prompts, the machine learning-based anomaly detection and reasoning tool 112 will invoke the anomalous log sub-sequence detection logic 114, which uses an AI/ML model such as a GNN model to detect whether input system logs include any anomalies and, if so, anomalous sub-sequences within the input system logs (e.g., sequences of message identifiers (IDs) within the logs which correspond to the detected anomalies). This may include utilizing the log parsing and embedding logic 116 to generate graph structures representing log sequences and log descriptions, and performing anomaly detection on such generated graph structures utilizing the GNN model. The machine learning-based anomaly detection and reasoning tool 112 is further configured to utilize the log parsing and embedding logic 116 to generate vector embeddings of the input system logs which have detected anomalies. The machine learning-based anomaly detection and reasoning tool 112 uses the anomalous log sub-sequence reasoning logic 118 to search for historical logs having anomalies (e.g., from the anomaly database 108) having vector embeddings which are similar to those of the input system logs which have detected anomalies (e.g., using cosine similarity). The similar historical logs having anomalies (and corresponding anomaly reasoning information) are selected as context for prompts to the LLM using RAG processing, which outputs the anomaly reasoning for the detected anomalous log sub-sequences.

At least portions of the machine learning-based anomaly detection and reasoning tool 112, the anomalous log sub-sequence detection logic 114, the log parsing and embedding logic 116 and the anomalous log sub-sequence reasoning logic 118 may be implemented at least in part in the form of software that is stored in memory and executed by a processor.

It is to be appreciated that the particular arrangement of the client devices 102, the IT infrastructure 105, the anomaly database 108 and the development platform 110 illustrated in the FIG. 1 embodiment is presented by way of example only, and alternative arrangements can be used in other embodiments. As discussed above, for example, the development platform 110 (or portions of components thereof, such as one or more of the machine learning-based anomaly detection and reasoning tool 112, the anomalous log sub-sequence detection logic 114, the log parsing and embedding logic 116 and the anomalous log sub-sequence reasoning logic 118) may in some embodiments be implemented internal to the IT infrastructure 105.

The development platform 110 and other portions of the information processing system 100, as will be described in further detail below, may be part of cloud infrastructure.

The development platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the anomaly database 108 and the development platform 110 or components thereof (e.g., the machine learning-based anomaly detection and reasoning tool 112, the anomalous log sub-sequence detection logic 114, the log parsing and embedding logic 116 and the anomalous log sub-sequence reasoning logic 118) may be implemented on respective distinct processing platforms, although numerous other arrangements are possible. For example, in some embodiments at least portions of the development platform 110 and one or more of the client devices 102, the IT infrastructure 105, the IT assets 106 and/or the anomaly database 108 are implemented on the same processing platform. A given client device (e.g., 102-1) can therefore be implemented at least in part within at least one processing platform that implements at least a portion of the development platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the anomaly database 108 and the development platform 110, or portions or components thereof, to reside in different data centers. Numerous other distributed implementations are possible. The development platform 110 can also be implemented in a distributed manner across multiple data centers.

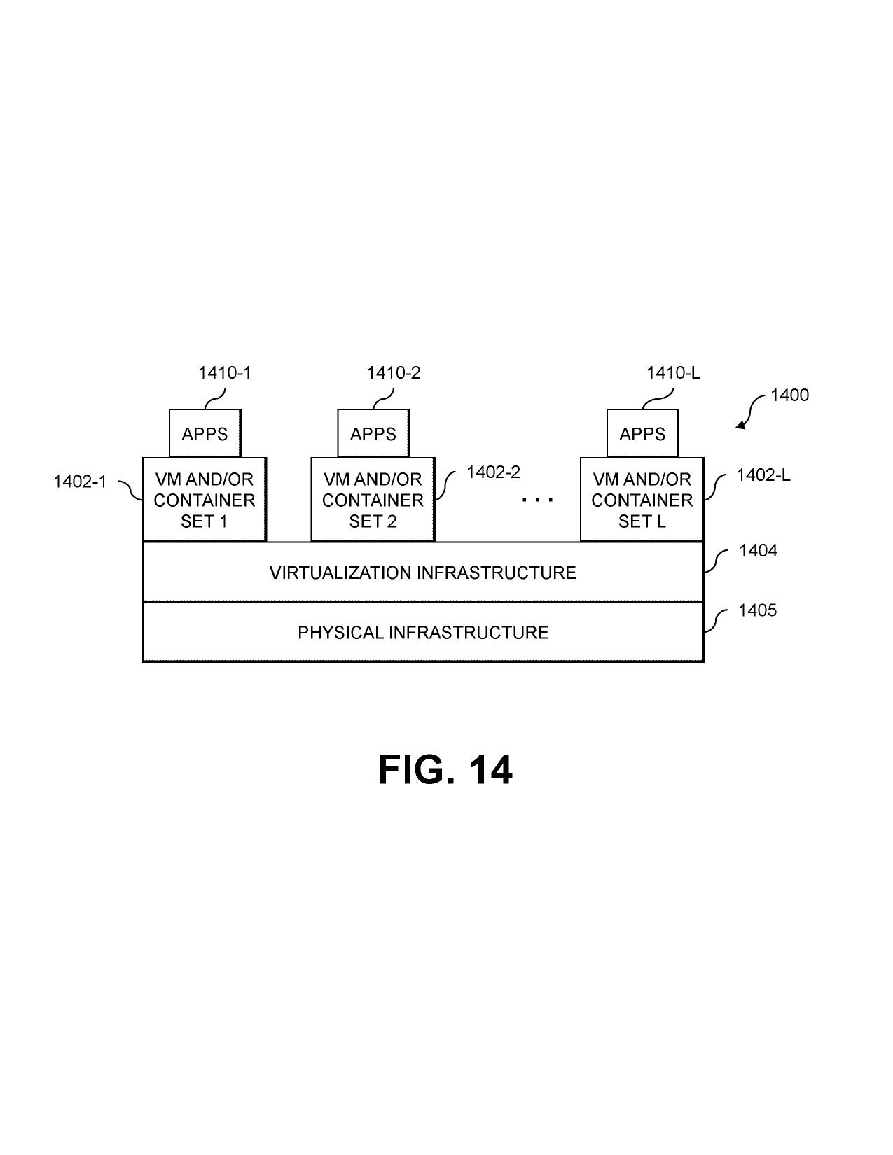

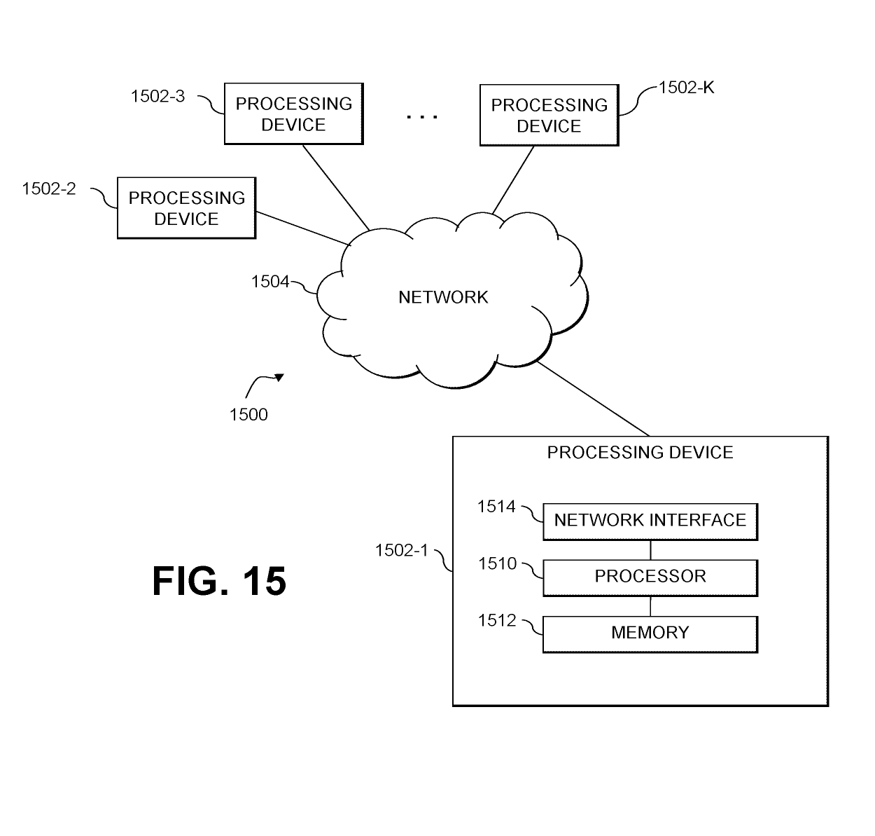

Additional examples of processing platforms utilized to implement the development platform 110 and other components of the information processing system 100 in illustrative embodiments will be described in more detail below in conjunction with FIGS. 14 and 15.

It is to be understood that the particular set of elements shown in FIG. 1 for machine learning-based log anomaly detection is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

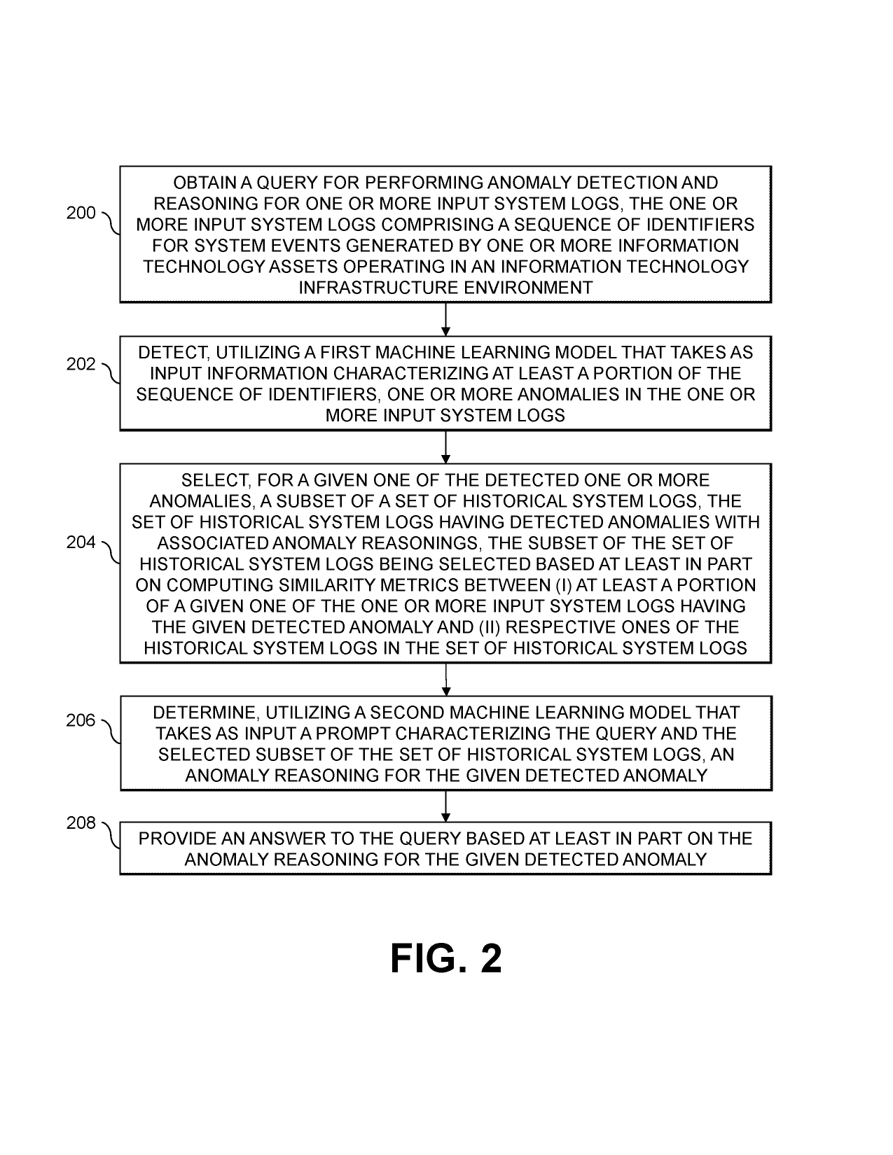

An exemplary process for machine learning-based log anomaly detection will now be described in more detail with reference to the flow diagram of FIG. 2. It is to be understood that this particular process is only an example, and that additional or alternative processes for machine learning-based log anomaly detection may be used in other embodiments.

In this embodiment, the process includes steps 200 through 208. These steps are assumed to be performed by the development platform 110 utilizing the machine learning-based anomaly detection and reasoning tool 112, the anomalous log sub-sequence detection logic 114, the log parsing and embedding logic 116 and the anomalous log sub-sequence reasoning logic 118. The process begins with step 200, obtaining a query for performing anomaly detection and reasoning for one or more input system logs. The one or more input system logs comprise a sequence of identifiers for system events generated by one or more IT assets operating in an IT infrastructure environment.

In step 202, one or more anomalies are detected in the one or more input system logs utilizing a first machine learning model that takes as input information characterizing at least a portion of the sequence of identifiers. The first machine learning model may comprise a GNN. The information characterizing at least a portion of the sequence of identifiers that is input to the first machine learning model in step 202 may comprise a graph data structure. The graph data structure may comprise nodes representing the system events generated by the one or more IT assets operating in the IT infrastructure environment and directed edges between the nodes represent an ordering of the system events generated by the one or more IT assets operating in the IT infrastructure environment. At least a given one of the nodes in the graph data structure may be further associated with at least one of a label encoded severity of a given system event represented by the given node and an embedding characterizing a message description for a given system event represented by the given node. In some embodiments, the GNN is configured to perform a first binary classification using a first graph convolutional network to detect the one or more anomalies in the one or more input system logs, and to perform a second binary classification using a second graph convolutional network to identify, for each of the detected one or more anomalies in the one or more input system logs, a corresponding anomalous sub-sequence of the sequence of identifiers representing that detected anomaly. The first graph convolutional network may be trained using the set of historical system logs with detected anomalies and an additional set of historical system logs without detected anomalies, and the second graph convolutional network may be trained using the set of historical system logs with detected anomalies but not the additional set of historical system logs without detected anomalies.

The FIG. 2 process continues with step 204, selecting, for a given one of the detected one or more anomalies, a subset of a set of historical system logs, the set of historical system logs having detected anomalies with associated anomaly reasonings. The subset of the set of historical system logs are selected based at least in part on computing similarity metrics between (i) at least a portion of a given one of the one or more input system logs having the given detected anomaly and (ii) respective ones of the historical system logs in the set of historical system logs. The FIG. 2 process may further include detecting, utilizing the first machine learning model, an anomalous sub-sequence of the sequence of identifiers representing a given detected anomaly. The computed similarity metrics comprise, for a given historical system log in the set of historical system logs and the given detected anomaly, a cosine similarity computed between: a first vector embedding of a given historical sequence of identifiers for system events in a given dictionary string generated for the given historical system log; and a second vector embedding of the anomalous sub-sequence of the sequence of identifiers representing the given detected anomaly. The given dictionary string generated for the given historical system log may comprise: a log description; the given historical sequence of identifiers for system events; at least one anomalous identifier in the given historical sequence of identifiers for the system events; and an anomaly reasoning for the at least one anomalous identifier. The anomalous sub-sequence of the sequence of identifiers representing the given detected anomaly may comprise a first identifier for a first anomalous system event generated by the one or more IT assets operating in the IT infrastructure environment, a second anomalous system event generated by the one or more IT assets operating in the IT infrastructure environment, and one or more non-anomalous system events generated by the one or more IT assets operating in the IT infrastructure environment occurring between the first anomalous system event and the second anomalous system event.

In step 206, an anomaly reasoning for the given detected anomaly is determined utilizing a second machine learning model that takes as input a prompt characterizing the query and the selected subset of the set of historical system logs. The second machine learning model may comprise an LLM. In some embodiments, the first machine learning model is pre-trained with domain knowledge associated with the one or more IT assets operating in the IT infrastructure environment, and the second machine learning model is not pre-trained with the domain knowledge associated with the one or more IT assets operating in the IT infrastructure environment.

An answer to the query is provided in step 208 based at least in part on the anomaly reasoning for the given detected anomaly. The reasoning for the given detected anomaly characterizes a root cause of the given detected anomaly, and the FIG. 2 process may further include modifying a configuration of at least one of the one or more IT assets operating in the IT infrastructure environment to address the root cause of the given detected anomaly.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

In product development and testing, such as for software products, hardware products or other IT assets, log analysis is one of the key activities where product engineers check to see if all the functionalities are performing as desired. Logs are generated across product types, and typically the log event sequences will vary with every product type. Various machine learning-based log anomaly detection algorithms use log event sequences to detect system anomalies. These techniques often use quantitative relational, sequential or spatial patterns of log event sequences to detect anomalies. Large Language Models (LLMs) using Retrieval Augment Generation (RAG) functionality or finetuning may also be used for log anomaly detection tasks.

Machine learning-based log anomaly detection algorithms may be trained or fine-tuned with domain knowledge for system anomaly detection, though such machine learning-based log anomaly detection algorithms lack the interaction capability of LLMs and are further not able to perform reasoning for detected anomalies. LLMs can interact well with users, but LLMs do not possess the domain knowledge needed for anomaly detection and reasoning. Fine-tuning LLMs for domain-specific knowledge requires significant infrastructure and resources. Further, LLMs are primarily tuned for text generation, and may not be as effective as task-specific deep neural networks for anomaly detection. Training specialized models can yield better results for tasks like anomaly detection.

Illustrative embodiments provide technical solutions which overcome technical challenges with conventional approaches, through leveraging the advantages of both machine learning-based log anomaly detection and LLMs, using a custom LLM agent, referred to herein as a Log Anomaly Detection and Reasoning (LADAR) agent. In some embodiments, the technical solutions utilize a Graph Neural Network (GNN)-based log sub-sequence anomaly detection algorithm, which is trained with historical logs where anomalies are identified. This trained model is used as a tool within the LLM agent framework to identify anomalies. Upon feeding the LLM with a log file to be analyzed, a data preprocessing step converts the logs into an LLM-understandable format. The LADAR agent is then called up, which initiates the task of using the pre-trained GNN model to detect anomalies. Following this anomaly detection, the LADAR agent calls an RAG process to find historical anomalies (along with their reasons, which may be natural language descriptions) similar to the detected anomalies. Through this RAG processing, the LLM can reason out the detected anomalies. The technical solutions described herein are thus able to accurately analyze for anomalous log sub-sequences using a lightweight GNN-based model, and perform reasoning on detected anomalous log sub-sequences using RAG and overall interaction with an LLM. The technical solutions described herein can thus provide a framework which utilizes the LADAR agent to bring domain-specific knowledge to the LLM without having to fine-tune the LLM.

In some embodiments, a custom LLM-based agent, referred to herein as the LADAR agent, is utilized to detect and reason anomalous log sub-sequences in system logs. To do so, the LADAR agent can leverage a GNN model trained with domain knowledge for anomaly detection and using RAG processing to find similar historical anomalies and their reasons to perform reasoning on detected anomalies with an LLM. Advantageously, the LLM does not need to be fine-tuned with domain-specific knowledge (e.g., for anomaly detection for the software/hardware products or other IT assets that are being tested, developed or operated). The LADAR agent, through integration of a GNN or other anomaly detection model trained with domain-specific knowledge and RAG processing with an LLM, brings contextual and interactive capability to the overall framework. The LADAR agent, in some embodiments, integrates a custom trained, lightweight GNN model for domain-specific knowledge. This integration eliminates the need for fine-tuning the LLM for the domain-specific task of anomaly detection, which greatly reduces the infrastructure needed for training and deploying anomaly detection and reasoning services. Advantageously, the LADAR agent combines the domain knowledge of the custom trained, lightweight GNN model for anomaly detection and the interactive capabilities of LLMs. It should be noted that while various embodiments are described with respect to the use of a GNN model for anomaly detection, the LADAR agent may be configured for integration with any suitable machine learning or other algorithm for anomaly detection and is thus applicable in a wide range of applications and is scalable across multiple domains. The technical solutions described herein are also advantageously able to identify anomalous log sub-sequences within larger log sequences (e.g., which may include hundreds or thousands of message identifiers (IDs) or other types of event or log IDs), to assist users in pinpointing and resolving issues faster. Further, the technical solutions described herein are able to both identify anomalous log sub-sequences and perform anomaly reasoning using RAG functionality for the identified anomalous log sub-sequences, to assist users in performing root cause analysis on detected anomalies to resolve issues faster.

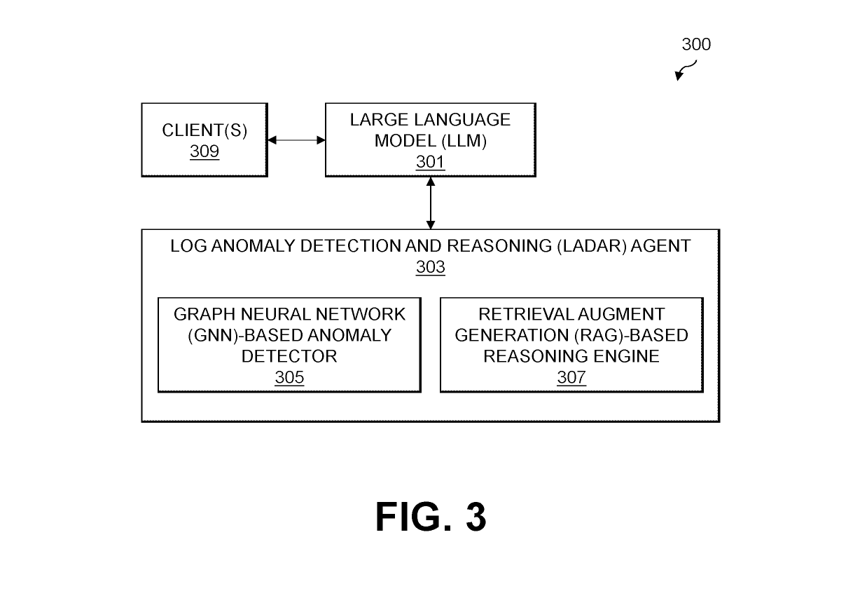

FIG. 3 shows a system 300 including an LLM 301 which utilizes a LADAR agent 303 implementing a GNN-based anomaly detector 305 and a RAG-based reasoning engine 307. The LLM 301 may receive queries or prompts from users or clients 309 for performing analysis of a set of system logs. The LLM 301 uses the LADAR agent 303 to first detect any anomalous log sub-sequences in the set of system logs using the GNN-based anomaly detector 305. On detecting anomalous log sub-sequences, the LADAR agent 303 uses the RAG-based reasoning engine 307 to find a “context” of historical logs or log sub-sequences (e.g., having detected reasons) that are similar to the detected anomalous log sub-sequences. This context is then used to augment queries or prompts which are supplied to the LLM 301, such that without fine-tuning the LLM 301, the output will leverage domain-specific knowledge. The LADAR agent 303 provides interactive capability for the overall processing or framework, which can be used as a standalone process to operate in a batch mode to process multiple log files in parallel.

In some embodiments, a process flow for machine learning-based detection of and reasoning for anomalies in system logs includes obtaining, at the LLM 301 from one of the clients 309, a query for performing anomaly detection and reasoning for a set of input system logs. The input system logs include a sequence of identifiers (e.g., message IDs) for system events which are generated by one or more IT assets operating in an IT infrastructure environment (e.g., as part of development and/or testing of the IT assets, during normal operation of the IT assets, etc.). The LLM 301 is configured to determine that the query is for performing log-based anomaly detection and reasoning, and invokes the LADAR agent 303. The LADAR agent 303 will parse the input system logs to generate a first data structure, suitable for input to a first machine learning model (e.g., a GNN), which characterizes the sequence of identifiers. In some embodiments, the first data structure includes a graph data structure with nodes representing system events (e.g., message IDs in the sequence) and directed edges between the nodes representing an ordering of the system events (e.g., the sequence of message IDs). The LADAR agent 303 uses the GNN-based anomaly detector 305 to (i) detect one or more anomalies in the input system logs and (ii) for each of the detected anomalies, to identify a corresponding anomalous sub-sequence of the sequence of identifiers which represents that detected anomaly. The LADAR agent 303 uses the output of the GNN-based anomaly detector 305 to generate a second data structure, the second data structure characterizing a selected subset of a set of historical system logs. The historical system logs have detected anomalies, and have known anomaly reasonings for the detected anomalies. The subset of the historical system logs are selected based at least in part on computing similarity metrics between the identified anomalous sub-sequences of the sequence of identifiers representing each of the detected anomalies and the historical system logs. This may include generating vector embeddings of the identified anomalous sub-sequences of the sequence of identifiers representing each of the detected anomalies, and computing the similarity (e.g., cosine similarity) of such vector embeddings with vector embeddings computed for the historical system logs (e.g., anomalous sub-sequences of message IDs or other identifiers for the detected anomalies associated with the historical system logs). The LADAR agent 303 uses the RAG-based reasoning engine 307 to generate a “context” for the LLM 301 that is to be included with a prompt input to the LLM 301, where the context includes the second data structure or at least a portion thereof, with the LLM 301 generating an output that characterizes anomaly reasonings for the detected anomalies in the input system logs. The LLM 301 provides an answer to the query back to the requesting one of the clients 309, with the answer being based on the output characterizing the anomaly reasonings for the detected anomalies in the input system logs.

It should be noted that the term “data structure” as used herein is intended to be broadly construed. A data structure, such as any single one of or combination of the first and second data structures referred to above, may provide a portion of a larger data structure, or any one of or combination of the first and second data structures may be combinations of multiple smaller data structures. Therefore, the first and second data structures referred to above may be different parts of a same overall data structure, or one or more of the first and second data structures could be made up of multiple smaller data structures. The data structures may include tables, vectors, embeddings, or various other data structures. In some embodiments, the data structures are specifically formatted or generated such that they are suitable for use as at least one of an input to and an output from a machine learning model. It should further be appreciated that “generating” a data structure may encompass, for example, populating an existing or previously-created data structure with one or more data items.

In some embodiments, an overall framework for machine learning-based log anomaly detection may be divided into three processing steps or stages, including: (1) GNN-based anomalous log sub-sequence detection; (2) generating vector embedding store for reasoning; and (3) processing logs using the LLM-based LADAR agent.

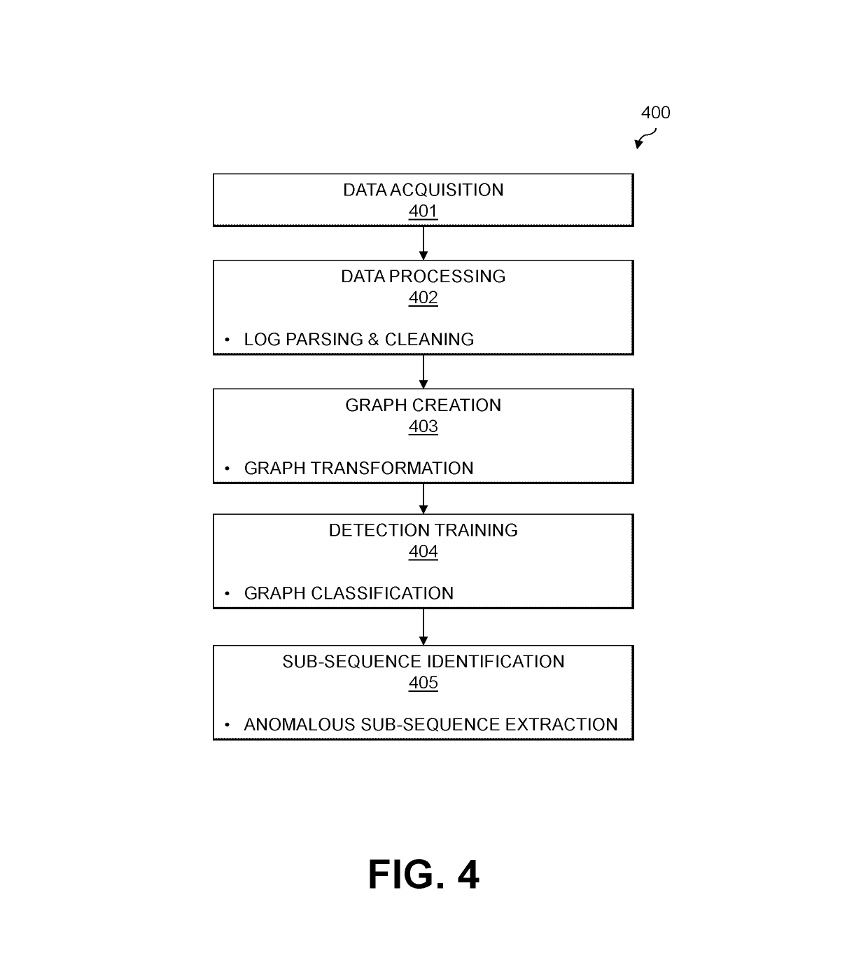

GNN-based anomalous log sub-sequence detection will now be described in further detail. The first step or stage is to train a GNN-based binary classification algorithm to detect the presence of any anomalous log sub-sequences in log files. The GNN is trained to identify log sub-sequences (e.g., sequences of message IDs, where each message ID is associated with a system event that is logged) where the likelihood of anomalous entries is high. FIG. 4 shows a process flow 400 for the GNN-based anomalous log sub-sequence detection, which includes data acquisition in block 401, data processing in block 402 (including log parsing and cleaning), graph creation in block 403 (including graph transformation), detection training in block 404 (including graph classification), and anomalous sub-sequence identification in block 405 (including extraction of anomalous log sub-sequences).

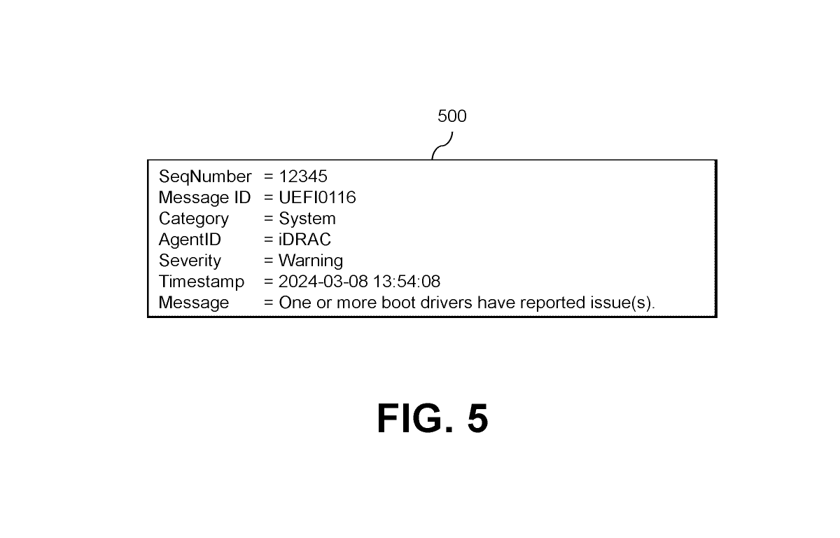

In the data acquisition block 401, the data for the GNN model training is obtained. In some embodiments, the data for the GNN model training is a set of logs collected from an Elastic Search or other database where the test system logs are stored. The log files may include sets of blocks (e.g., tens to hundreds of blocks), where each block represents a certain event happening within the system. FIG. 5 shows a sample system log block 500 generated during a system event. In this example, the system log block 500 includes a sequence number (SeqNumber or SeqNum), a message ID (msgID), category, agent ID (agentID), severity, timestamp and message. The collected logs are a combination of anomalous and non-anomalous logs. The anomalous logs are detected, including the information about the log sub-sequence which has the anomalous entry or entries within it.

In the data processing block 402, the system logs acquired in the data acquisition block 401 are parsed to formulate nodes and edges along with their corresponding features to create graphs. The logs, which are textual, are transformed into data frames or other data structures with all the available information in the logs being parsed and labeled. This includes the presence of anomalies and anomalous sub-sequences (e.g., of message IDs or other system event IDs). Each data frame includes a log identifier followed by the sequential message IDs and their corresponding severities. The message IDs and their corresponding severities are label encoded as a part of standardization. Information about the description associated with the message IDs is also collected. In cases where a message ID is not available, a unique identifier for each log block can be created based on unique message descriptions or any other field. Since GNN-based anomaly detection is utilized, the model can be fine-tuned with the revised identifier and then executed for anomaly detection.

In the graph creation block 403, a graph network is created based on the log-parsed data frames or other data structures, with the label-encoded message IDs as nodes and the sequence of message IDs leading to the connections or edges between the nodes. The edges are created in a directed manner, as the message ID sequence needs to be learned. The label encoded severity of each message ID is added as a node feature. Along with the severity, the message ID description is embedded using an embedding model and is added as a node feature.

In the detection training block 404, using the graphs created in the graph creation block 403, a binary classification using a Graph Convolutional Network (GCN) is designed for the detection of anomalies. This classification is created as a supervised algorithm, with the output being a binary class where 0 is non-anomalous and 1 is anomalous.

In the sub-sequence identification block 405, sub-sequence identification is carried out using the constructed graph and training a separate node classification model. This is also a binary classification based on GCN, but is at a node level for identifying the anomalous message IDs within the sequence of message IDs (or other event IDs or log sequences). This node classification training is carried out on only the anomalous log graphs (e.g., created graphs that are determined to have detected anomalies in the detection training block 404), and the result of this classification will be the list of message IDs within the logs which are anomalous, forming a sub-sequence with the main sequence of events. This is also a supervised method of training to detect the anomalous sub-sequences within the anomalous logs.

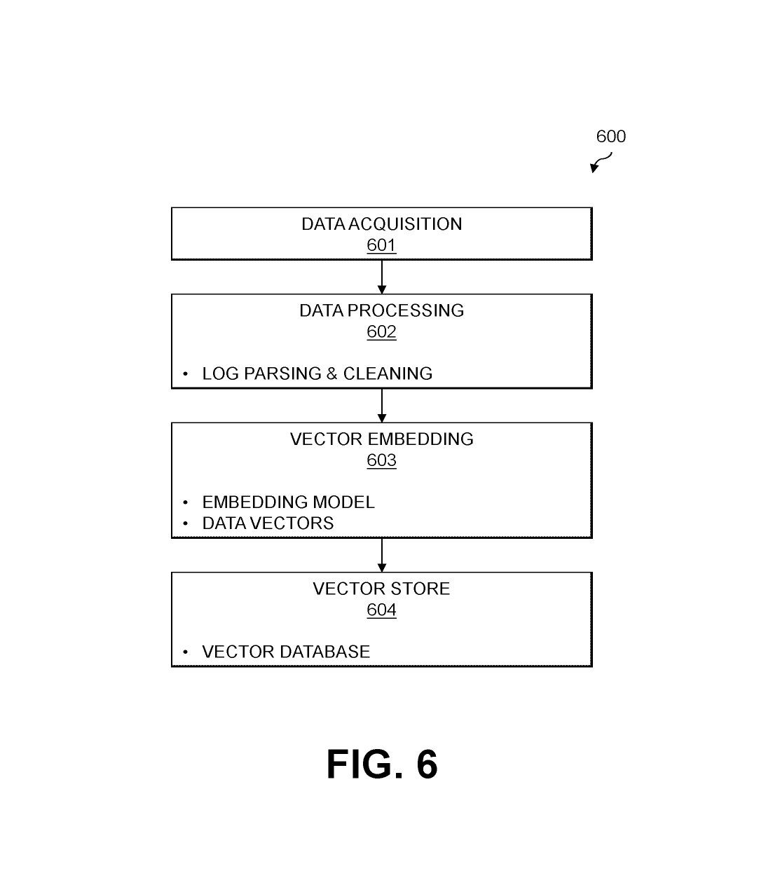

Generating the vector embedding store for anomaly reasoning will now be described in further detail. The second step or stage is to create a vector embedding of the log data to be used for reasoning on detected anomalies using LLM-based RAG processing. FIG. 6 shows a process flow 600 for generating the vector embedding store for anomaly reasoning, which includes data acquisition in block 601, data processing in block 602 (including log parsing and cleaning), vector embedding in block 603 (including an embedding model that produces data vectors), and a generating a vector store in block 604 (including creating or populating a vector database).

The data acquisition block 601 is similar to the data acquisition block 401 in the process flow 400, where log data (e.g., historical log data) is downloaded or otherwise obtained or retrieved from a log source (e.g., an Elastic Search or other log database). In the data acquisition block 601, however, only the log data for anomalous logs is retrieved.

In the data processing block 602, data frames or other data structures are designed with parsed log data, which will be transformed into an embedding and stored in a vector database for reasoning using RAG. The data frames or other data structures include natural language descriptions of the log files, their anomalies and associated reasoning (e.g., root cause), and their message ID sequence. The message ID sequence is label encoded (in a manner similar to that described above with respect to the data processing block 402). Except for the anomaly reason, the other columns are combined to form a dictionary string which will be vectorized in the vector embedding block 603.

In the vector embedding block 603, the dictionary strings created in the data processing block 602 are transformed into vectors using a pre-trained text embedding model. The output of this transformation is a vector of fixed length, which is stored along with the dictionary string in the vector database in the vector store block 604. These vectors will be used for RAG processing, where cosine similarity is calculated between an incoming log file that is to be analyzed and the historical anomalous logs (e.g., between vector embeddings of the incoming log file and the historical anomalous logs), and where the most similar (e.g., a threshold number of the historical anomalous logs having the highest cosine similarity with the incoming log file) are selected and used to generate a context for prompts or queries to the LLM for reasoning on the detected anomalies.

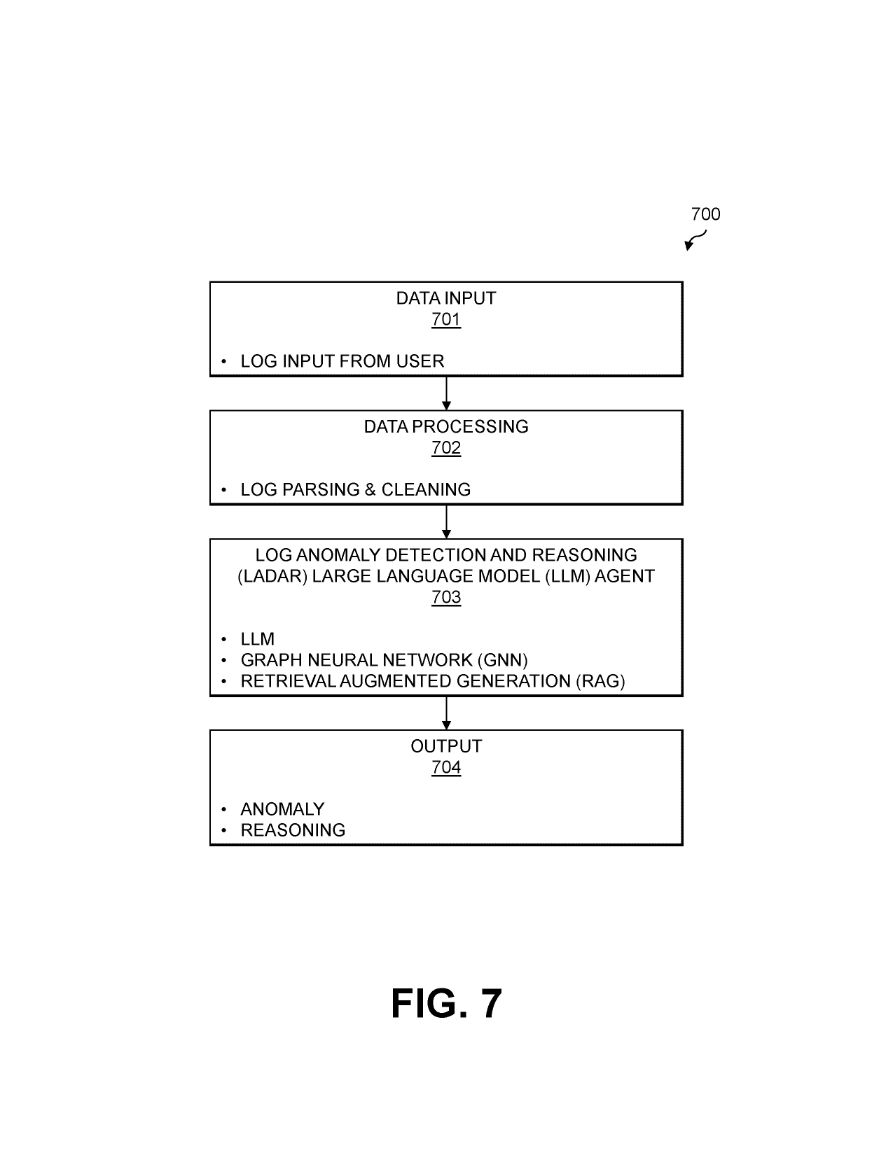

Processing with the LLM-based LADAR agent will now be described in further detail. The third step or stage is to integrate the GNN-based anomalous log sub-sequence detection from the first step or stage and the vector embedding store from the second step or stage to generate the complete anomaly detection and reasoning output. FIG. 7 shows a process flow 700 for the LLM-based LADAR agent processing, which includes data input in block 701 (including receiving input logs from users to be analyzed), data processing in block 702 (including log parsing and cleaning), LADAR LLM agent processing in block 703 (including use of an LLM, a GNN and RAG processing), and output in block 704 (including detection or anomalies and reasoning on the detected anomalies).

The data input block 701 includes receiving, as input, one or more log files to be tested for anomalies. The log files are assumed to include sequences of message IDs (or other system event or logging IDs), along with corresponding message or other log descriptions for each of the message IDs.

In the data processing block 702, the input log files and their corresponding log descriptions are parsed into data frames or other data structures for input to the GNN model for anomaly detection, and into dictionary strings for RAG processing used for reasoning on any detected anomalies. The data processing block 702 is similar to the data processing block 602 in the process flow 600.

The LADAR LLM agent block 703 includes utilization of the LADAR agent. The LADAR agent may be created, instantiated or otherwise generated using any suitable agent creation framework. The GNN model and RAG processing are created as tools with proper definitions that are understandable by the LLM model (e.g., in FIG. 3, the LADAR agent 303 includes the GNN-based anomaly detector 305 which implements the GNN model and the RAG-based reasoning engine 307 which implements the RAG functionality, which are accessible to the LLM 301). In some embodiments, the overall framework including the LADAR agent uses LangChain as a backbone. Based on the LLM that is used, the human and system prompts are created with the tool name (e.g., for the LADAR agent) and its definitions. This will allow the LLM to understand the functionality of the LADAR agent, and to utilize the LADAR agent to make the required calls to the GNN model and the RAG processing functionality. In some embodiments, the prompts for the LLM have a “Thought-Action” template integrated, which allows the LLM to follow a specific sequential pattern to solve the user query which includes anomaly detection and reasoning. In some embodiments, the LADAR agent is created as a Sequential Chain where the RAG processing call happens based on the output of the GNN model for anomaly detection.

The LLM is configured to first parse the input data frames or other data structures into a format (e.g., JavaScript Object Notation (JSON) format) that is suitable for input to the GNN model. The GNN model executes the anomaly detection algorithm to output the presence of any anomalies along with anomalous sub-sequences for the detected anomalies, if applicable. In the case where one or more anomalies are detected to be present by the GNN model, the LLM uses the LADAR agent to call the RAG processing, where the RAG processing takes as input the dictionary string having the log description, message ID sequence and the anomalous sub-sequence detected by the GNN model. The RAG processing will convert this input dictionary string into vector embeddings, and runs a similarity check with historical dictionary strings in the vector store. The best similar historical dictionary strings (e.g., a top X similar historical dictionary strings, where X is a configurable user parameter) along with their anomaly reasonings are retrieved and passed back to the LLM. The LLM is engineered with the prompt specifying a request to perform anomaly reasoning for anomalies detected in the current log (e.g., the anomalies detected using the GNN model), using the retrieved historical data (e.g., the best historical dictionary strings and their associated anomaly reasonings) as context.

In the output block 704, the LLM generates a final output based on the three inputs: (1) the historical dictionary strings with corresponding anomaly reasonings selected as “context” using the RAG processing; (2) the input log files and log descriptions, both converted into the dictionary string format; and (3) the GNN model output which will have the detected anomalous sub-sequences, if any. Based on these inputs, the LLM generates a formatted output to the user for further analysis and rectification or remediation of the detected anomalies.

An example use case will now be described, where server testing logs were considered. During a testing process, the server to be tested was operated while executing an extensive number of test cases, which generated log files (also referred to as server testing logs). In a conventional approach, following the successful execution of the test cases, a test engineer must manually analyze the server testing logs to check for any anomalies. These anomalies may be sequences which did not cause any failure, but may lead to future failures. Using the technical solutions described herein, the anomaly detection and reasoning processes are advantageously automated.

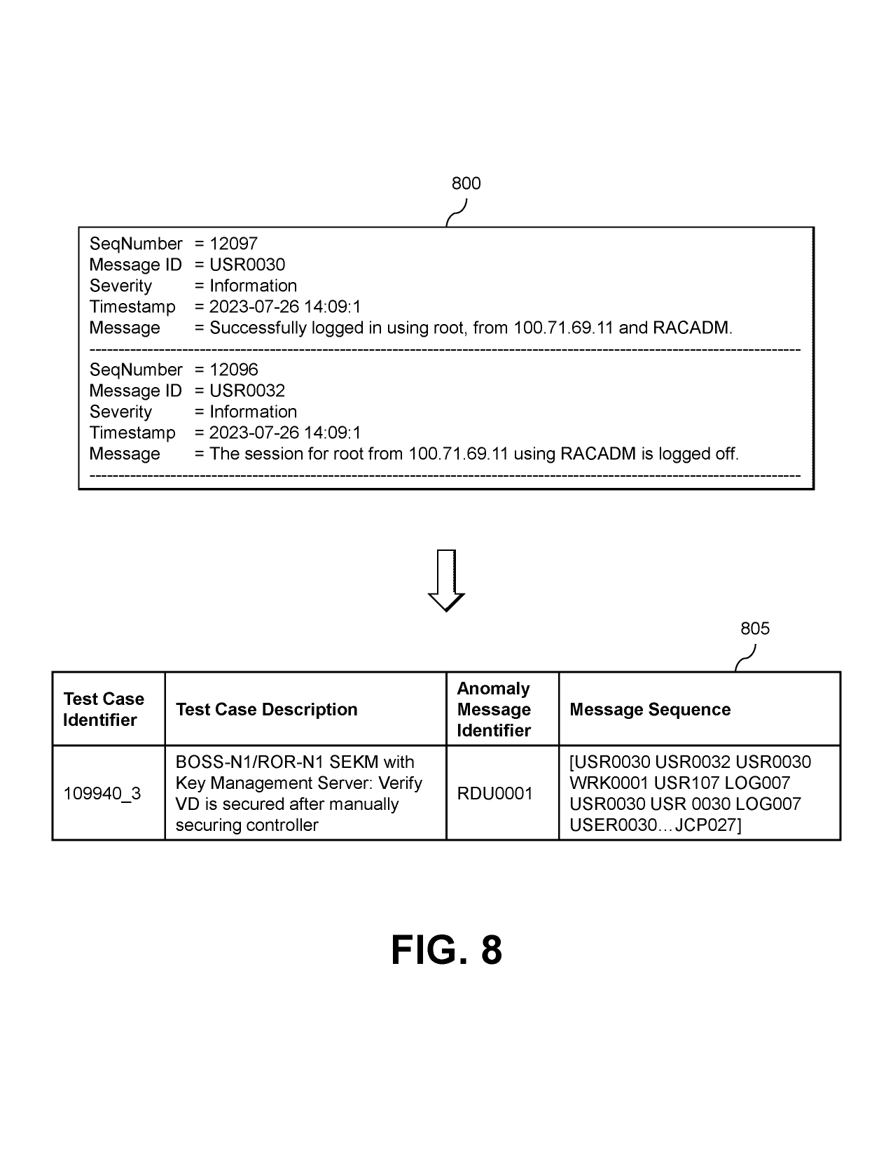

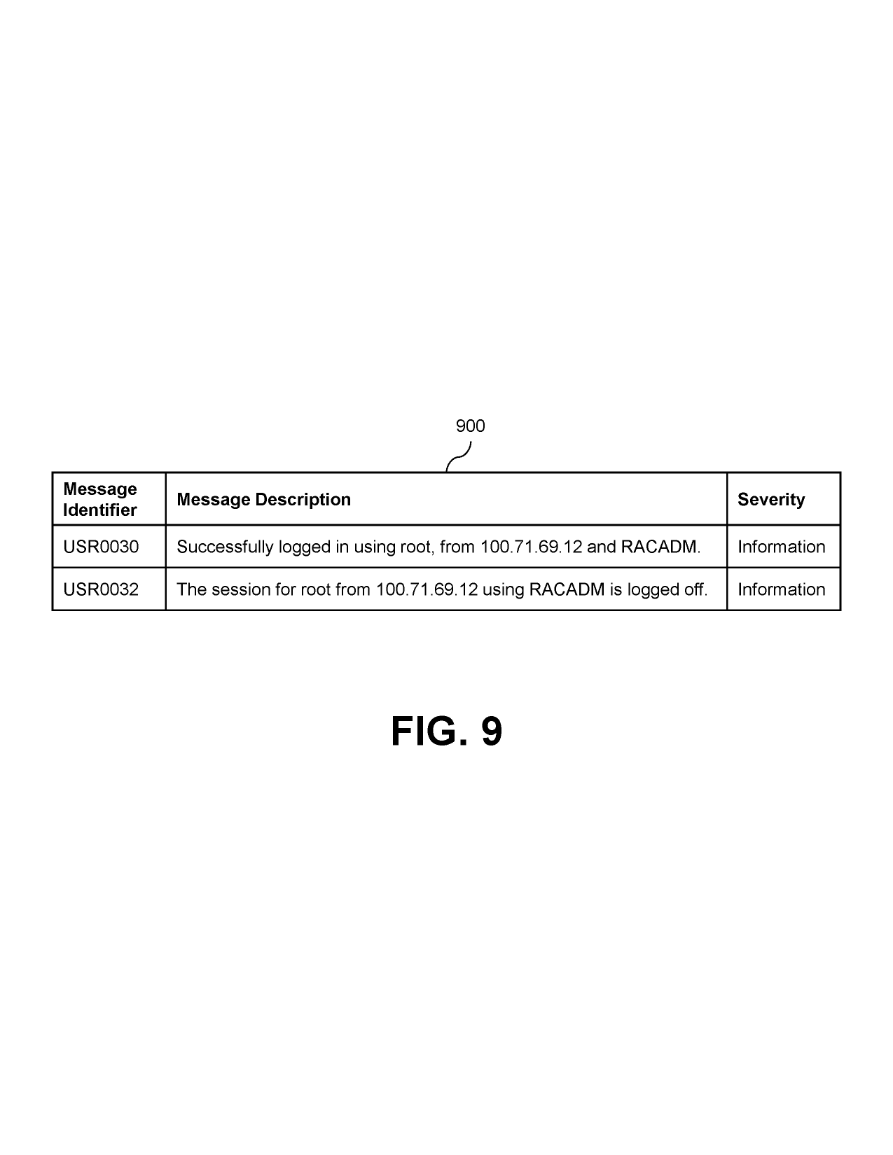

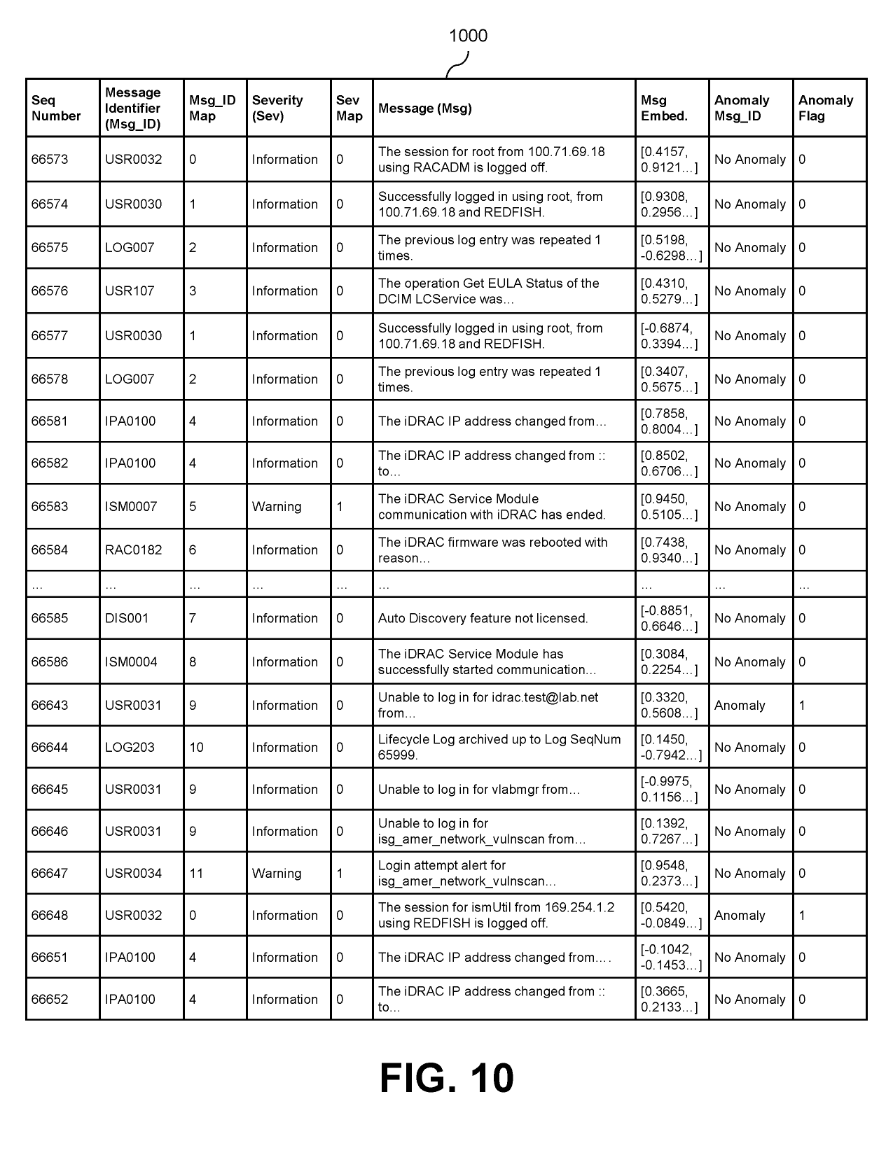

To begin, GNN-based anomalous sub-sequence detection is performed. This includes collecting a set of historical server logs (e.g., about 2000 historical server logs in this example implementation) from a database (e.g., an Elastic Search database) for the analysis. This set of historical server logs includes both anomalous and non-anomalous logs, with the anomalous logs being only a small percentage (e.g., about 5%) of the complete set of historical server logs considered. The historical server logs were split into training and testing sets, with an 80:20 ratio. Both the training and testing data are processed into data frames or other data structures, as illustrated in FIG. 8, which shows system log blocks 800 converted to a data frame 805. The message ID sequence in the data frame 805 is transformed into a label encoding for further processing using the GNN. The severity is also added to each of the message IDs or codes in the sequence. Along with this data, the message ID along with the corresponding description is also collected. This is illustrated in FIG. 9, which shows a table 900 data structure of message IDs, descriptions and severity. FIG. 10 shows a table 1000 data structure of an overall data frame used in subsequent processing steps.

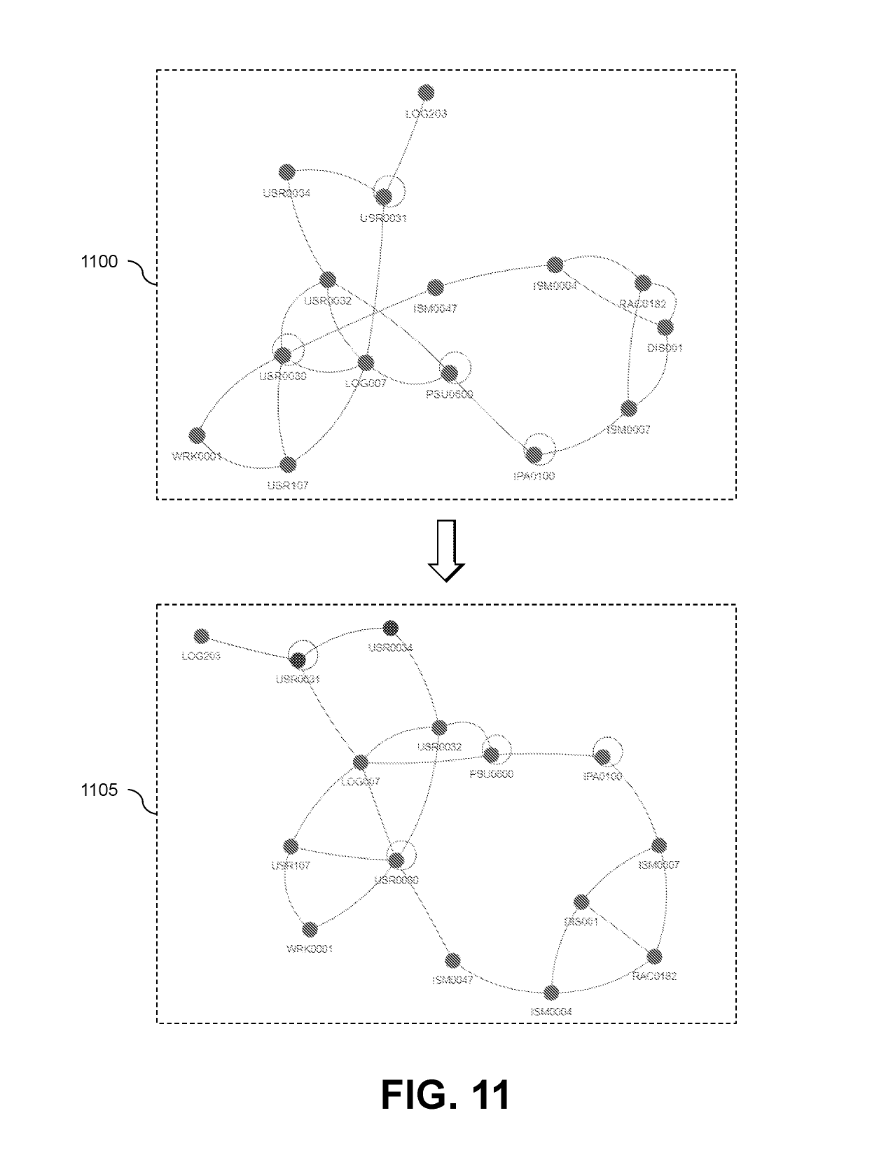

A graph network is then created using the generated data frame, and the GCN-based binary classifications for anomaly detection and anomalous sub-sequence identification are carried out. FIG. 11 shows building of the GNN model, where an initial graph 1100 is supplemented with detected anomaly information (for message IDs USR0031 and USR0034) to generate graph 1105. In this example dataset, an accuracy of 94% on anomaly detection and 93% on node classification for sub-sequence identification is achieved.

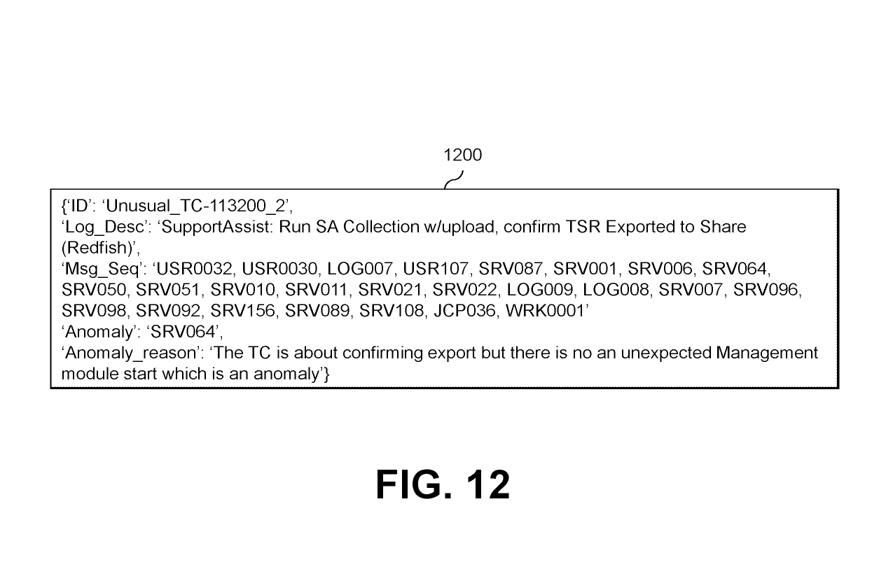

Generating the vector embedding store for anomaly reasoning is then performed. From the collected historical server logs, the anomalous logs are separated, since the vector store is created only for the anomalous logs. As a part of the data processing, the collected anomalous logs are parsed to formulate dictionary strings. FIG. 12 shows an example dictionary string data structure 1200 with a sample data dictionary for vector embedding. From this dictionary, the log description, message ID sequence and the anomaly reason were used for vector transformation, and the log ID and anomalous sub-sequence were used as the metadata. In the example use case, a nomac-ai-/nomic-embed-text-v1 embedding model was used locally for transforming the dictionary string into embeddings. This model has a context length of 8192 tokens, and generates an embedding vector of 768 dimensions. This embedding along with the text was stored for the RAG processing for anomaly reasoning.

Processing using the LLM-based LADAR agent is then performed. Data processing is performed for transforming an incoming log file to a format suitable for input to the GNN. The processed log file is passed to the LLM-based LADAR agent, which uses the GNN model and RAG processing as tools. The prompt for this LLM agent may be based on an agent tooling prompt available in LangChain for Sequential JSON chain. The prompt is modified to add instructions on when to use which tool (e.g., the GNN and the RAG processing) along with the input format for the tools. Based on the LLM tool call, the first step is to call the GNN which converts the log sequence (e.g., the sequence of message IDs) into a graph embedding and does a binary classification to check for the presence of anomalies based on the learning that the GNN received during the training process. If the log has anomalies, then the node classification algorithm is executed to identify the anomalous sub-sequence within the log, where the anomalous sub-sequence includes the anomalous entry or entries (e.g., message IDs) within the log file. This anomalous sub-sequence is passed back to the LLM to get the anomaly reasoning using RAG processing. The dictionary string is created with the log description, the message ID sequence and anomalous message ID sub-sequence. This dictionary string is then converted into an embedding (e.g., using the nomic-ai/nomic-embed-text-v1 model). Cosine similarity calculations are then performed to get the closest matches between the input log and the historical logs present in the vector database. With the closest matches retrieved, the closest matching historical logs and their anomaly reasonings are passed to the LLM as context using RAG processing, such that the LLM is able to generate an output with anomaly reasonings for any detected anomalies in the input log file.

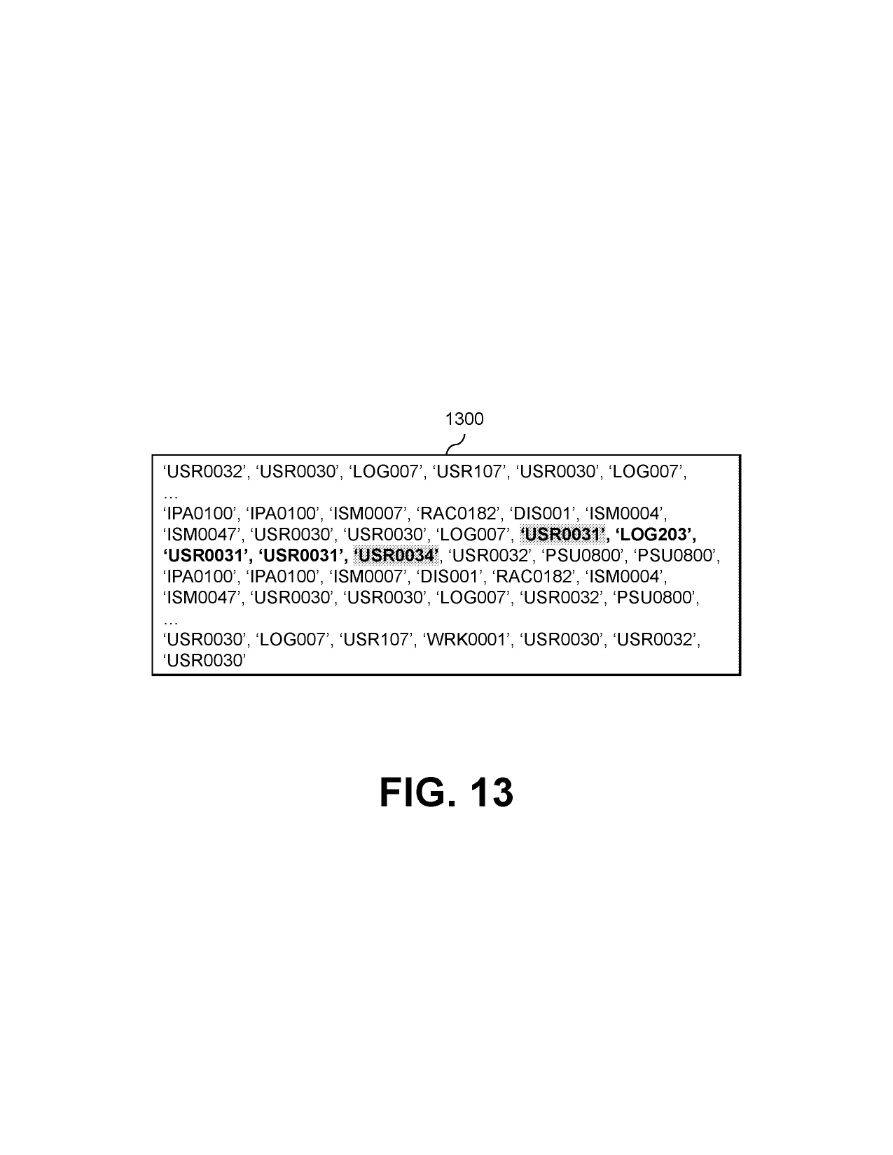

In some cases, there may be arbitrary user actions which are not observed by the GNN for anomaly detection. Thus, there are scenarios where there could be some arbitrary user actions being logged. These user actions could be or include anomalies, based on historical logs used to train the GNN anomaly detection model. FIG. 13 shows an example log sequence 1300. In the log sequence 1300, the message IDs which are in bold form the anomalous sub-sequence, with the message IDs which are highlighted in gray being the message IDs for anomalous system events. While training, the GNN model tries to learn this pattern for detecting the anomalies by connecting sub-sequences of the message IDs. The GNN model also uses features like the message description to perform the detection, such that the detection becomes more accurate. In scenarios where a user performs the same operations multiple times repeating the same anomalous sub-sequence, the GNN model can identify this multiple arbitrary user action itself as an anomaly, as it has not seen such operations while training.

The technical solutions described herein can advantageously be used for the analysis of any type of system logs, through leveraging the LLM-based LADAR agent. The technical solutions described herein can be applied to hardware and software products or other IT assets (e.g., laptops/desktops, servers, data centers, cloud offerings, etc.) which are being developed, tested or otherwise operated in an IT infrastructure, and can assist engineers and subject matter experts (SMEs) to identify and resolve issues present in system logs. The technical solutions described herein can also be extended to support offerings for customer issues, including for issue identification and root cause analysis.

Conventional approaches, such as LLM-based methods like RAGLog or LogPrompt, may be used to identify anomalies in log files with interaction using LLMs. Such approaches, however, may require significant infrastructure and resources for suitably fine-tuning the LLMs with domain knowledge needed for anomaly detection. The technical solutions described herein, in contrast, utilize a unique combination of interaction with an LLM that is able to use the LADAR agent to integrate with a GNN and RAG processing to pinpoint anomalous sub-sequences (e.g., of message IDs or other identifiers of system events which are logged) within logs. GNN-based anomaly detection like LogGD provides a method that is only able to classify the presence of anomalies. The technical solutions described herein, in contrast, are able to classify the presence of anomalies and also identify the anomalous sub-sequences within logs, thereby facilitating downstream processing for anomaly detection and reasoning.

Conventional approaches for reasoning on detected anomalies often require LLM fine-tuning, which requires significant infrastructure, time and resources. The technical solutions described herein, however, use an agent-based integration of RAG-based anomaly reasoning, such that anomaly-specific response capability is achieved with minimal needed infrastructure. Conventional approaches which directly utilize LLMs for tasks like anomaly detection may not provide acceptable accuracy, as LLMs are primarily used for text generation. The technical solutions described herein, in contrast, do not rely on the LLM for anomaly detection and instead leverage a task-specific anomaly detection model (e.g., a GNN model) for anomaly detection and anomalous sub-sequence identification, which can yield better results and accuracy.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for machine learning-based anomaly detection and reasoning using system logs will now be described in greater detail with reference to FIGS. 14 and 15. Although described in the context of system 100, these platforms may also be used to implement at least portions of other information processing systems in other embodiments.

FIG. 14 shows an example processing platform comprising cloud infrastructure 1400. The cloud infrastructure 1400 comprises a combination of physical and virtual processing resources that may be utilized to implement at least a portion of the information processing system 100 in FIG. 1. The cloud infrastructure 1400 comprises multiple virtual machines (VMs) and/or container sets 1402-1, 1402-2, . . . 1402-L implemented using virtualization infrastructure 1404. The virtualization infrastructure 1404 runs on physical infrastructure 1405, and illustratively comprises one or more hypervisors and/or operating system level virtualization infrastructure. The operating system level virtualization infrastructure illustratively comprises kernel control groups of a Linux operating system or other type of operating system.

The cloud infrastructure 1400 further comprises sets of applications 1410-1, 1410-2, . . . 1410-L running on respective ones of the VMs/container sets 1402-1, 1402-2, . . . 1402-L under the control of the virtualization infrastructure 1404. The VMs/container sets 1402 may comprise respective VMs, respective sets of one or more containers, or respective sets of one or more containers running in VMs.

In some implementations of the FIG. 14 embodiment, the VMs/container sets 1402 comprise respective VMs implemented using virtualization infrastructure 1404 that comprises at least one hypervisor. A hypervisor platform may be used to implement a hypervisor within the virtualization infrastructure 1404, where the hypervisor platform has an associated virtual infrastructure management system. The underlying physical machines may comprise one or more distributed processing platforms that include one or more storage systems.

In other implementations of the FIG. 14 embodiment, the VMs/container sets 1402 comprise respective containers implemented using virtualization infrastructure 1404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1400 shown in FIG. 14 may represent at least a portion of one processing platform. Another example of such a processing platform is processing platform 1500 shown in FIG. 15.

The processing platform 1500 in this embodiment comprises a portion of system 100 and includes a plurality of processing devices, denoted 1502-1, 1502-2, 1502-3, . . . 1502-K, which communicate with one another over a network 1504.

The network 1504 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1502-1 in the processing platform 1500 comprises a processor 1510 coupled to a memory 1512.

The processor 1510 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 1512 may comprise random access memory (RAM), read-only memory (ROM), flash memory or other types of memory, in any combination. The memory 1512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1502-1 is network interface circuitry 1514, which is used to interface the processing device with the network 1504 and other system components, and may comprise conventional transceivers.

The other processing devices 1502 of the processing platform 1500 are assumed to be configured in a manner similar to that shown for processing device 1502-1 in the figure.

Again, the particular processing platform 1500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for machine learning-based anomaly detection and reasoning using system logs as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to obtain a query for performing anomaly detection and reasoning for one or more input system logs, the one or more input system logs comprising a sequence of identifiers for system events generated by one or more information technology assets operating in an information technology infrastructure environment;
to detect, utilizing a first machine learning model that takes as input information characterizing at least a portion of the sequence of identifiers, one or more anomalies in the one or more input system logs;
to select, for a given one of the detected one or more anomalies, a subset of a set of historical system logs, the set of historical system logs having detected anomalies with associated anomaly reasonings, the subset of the set of historical system logs being selected based at least in part on computing similarity metrics between (i) at least a portion of a given one of the one or more input system logs having the given detected anomaly and (ii) respective ones of the historical system logs in the set of historical system logs;
to determine, utilizing a second machine learning model that takes as input a prompt characterizing the query and the selected subset of the set of historical system logs, an anomaly reasoning for the given detected anomaly; and
to provide an answer to the query based at least in part on the anomaly reasoning for the given detected anomaly.

2. The apparatus of claim 1 wherein the first machine learning model comprises a graph neural network.

3. The apparatus of claim 2 wherein the information characterizing said at least a portion of the sequence of identifiers comprises a graph data structure, the graph data structure comprising nodes representing the system events generated by the one or more information technology assets operating in the information technology infrastructure environment and directed edges between the nodes represent an ordering of the system events generated by the one or more information technology assets operating in the information technology infrastructure environment.

4. The apparatus of claim 3 wherein at least a given one of the nodes in the graph data structure is further associated with a label encoded severity of a given system event represented by the given node.

5. The apparatus of claim 3 wherein at least a given one of the nodes in the graph data structure comprises an embedding characterizing a message description for a given system event represented by the given node.

6. The apparatus of claim 3 wherein the graph neural network is configured:
to perform a first binary classification using a first graph convolutional network to detect the one or more anomalies in the one or more input system logs; and
to perform a second binary classification using a second graph convolutional network to identify, for each of the detected one or more anomalies in the one or more input system logs, a corresponding anomalous sub-sequence of the sequence of identifiers representing that detected anomaly.

7. The apparatus of claim 6 wherein the first graph convolutional network is trained using the set of historical system logs with detected anomalies and an additional set of historical system logs without detected anomalies, and wherein the second graph convolutional network is trained using the set of historical system logs with detected anomalies but not the additional set of historical system logs without detected anomalies.

8. The apparatus of claim 1 wherein the at least one processing device is further configured to detect, utilizing the first machine learning model, an anomalous sub-sequence of the sequence of identifiers representing given detected anomaly.

9. The apparatus of claim 8 wherein the anomalous sub-sequence of the sequence of identifiers representing the given detected anomaly comprises a first identifier for a first anomalous system event generated by the one or more information technology assets operating in the information technology infrastructure environment, a second anomalous system event generated by the one or more information technology assets operating in the information technology infrastructure environment, and one or more non-anomalous system events generated by the one or more information technology assets operating in the information technology infrastructure environment occurring between the first anomalous system event and the second anomalous system event.

10. The apparatus of claim 8 wherein the computed similarity metrics comprise, for a given historical system log in the set of historical system logs and the given detected anomaly, a cosine similarity computed between:
a first vector embedding of a given historical sequence of identifiers for system events in a given dictionary string generated for the given historical system log; and
a second vector embedding of the anomalous sub-sequence of the sequence of identifiers representing the given detected anomaly.

11. The apparatus of claim 10 wherein the given dictionary string generated for the given historical system log comprises: a log description; the given historical sequence of identifiers for system events; at least one anomalous identifier in the given historical sequence of identifiers for the system events; and an anomaly reasoning for the at least one anomalous identifier.

12. The apparatus of claim 1 wherein the second machine learning model comprises a large language model.

13. The apparatus of claim 1 wherein the first machine learning model is pre-trained with domain knowledge associated with the one or more information technology assets operating in the information technology infrastructure environment, and the second machine learning model is not pre-trained with the domain knowledge associated with the one or more information technology assets operating in the information technology infrastructure environment.

14. The apparatus of claim 1 wherein the reasoning for the given detected anomaly characterizes a root cause of the given detected anomaly, and wherein the at least one processing device is further configured to modify a configuration of at least one of the one or more information technology assets operating in the information technology infrastructure environment to address the root cause of the given detected anomaly.

15. A computer program product comprising a non-transitory processor-readable storage medium having stored therein program code of one or more software programs, wherein the program code when executed by at least one processing device causes the at least one processing device:
to obtain a query for performing anomaly detection and reasoning for one or more input system logs, the one or more input system logs comprising a sequence of identifiers for system events generated by one or more information technology assets operating in an information technology infrastructure environment;
to detect, utilizing a first machine learning model that takes as input information characterizing at least a portion of the sequence of identifiers, one or more anomalies in the one or more input system logs;
to select, for a given one of the detected one or more anomalies, a subset of a set of historical system logs, the set of historical system logs having detected anomalies with associated anomaly reasonings, the subset of the set of historical system logs being selected based at least in part on computing similarity metrics between (i) at least a portion of a given one of the one or more input system logs having the given detected anomaly and (ii) respective ones of the historical system logs in the set of historical system logs;
to determine, utilizing a second machine learning model that takes as input a prompt characterizing the query and the selected subset of the set of historical system logs, an anomaly reasoning for the given detected anomaly; and
to provide an answer to the query based at least in part on the anomaly reasoning for the given detected anomaly.

16. The computer program product of claim 15 wherein the first machine learning model comprises a graph neural network and the second machine learning model comprises a large language model.

17. The computer program product of claim 15 wherein the first machine learning model is pre-trained with domain knowledge associated with the one or more information technology assets operating in the information technology infrastructure environment, and the second machine learning model is not pre-trained with the domain knowledge associated with the one or more information technology assets operating in the information technology infrastructure environment.

18. A method comprising:
obtaining a query for performing anomaly detection and reasoning for one or more input system logs, the one or more input system logs comprising a sequence of identifiers for system events generated by one or more information technology assets operating in an information technology infrastructure environment;
detecting, utilizing a first machine learning model that takes as input information characterizing at least a portion of the sequence of identifiers, one or more anomalies in the one or more input system logs;
selecting, for a given one of the detected one or more anomalies, a subset of a set of historical system logs, the set of historical system logs having detected anomalies with associated anomaly reasonings, the subset of the set of historical system logs being selected based at least in part on computing similarity metrics between (i) at least a portion of a given one of the one or more input system logs having the given detected anomaly and (ii) respective ones of the historical system logs in the set of historical system logs;
determining, utilizing a second machine learning model that takes as input a prompt characterizing the query and the selected subset of the set of historical system logs, an anomaly reasoning for the given detected anomaly; and
providing an answer to the query based at least in part on the anomaly reasoning for the given detected anomaly;
wherein the method is performed by at least one processing device comprising a processor coupled to a memory.

19. The method of claim 18 wherein the first machine learning model comprises a graph neural network and the second machine learning model comprises a large language model.

20. The method of claim 18 wherein the first machine learning model is pre-trained with domain knowledge associated with the one or more information technology assets operating in the information technology infrastructure environment, and the second machine learning model is not pre-trained with the domain knowledge associated with the one or more information technology assets operating in the information technology infrastructure environment.
